(19) United States
(12) Patent Application Publication
(10) Pub. No.: US 2012/0292901 A1
(43) Pub. Date: Nov. 22, 2012

(54) PLUMBING FITTING

(76) Inventor: Jin Sik BONG, Seoul (KR)

(21) Appl. No.: 13/112,826

(22) Filed: May 20, 2011

(51) Int. Cl. F16L 15/00; F16L 21/00

(52) U.S. Cl. 285/390; 285/399

(57) ABSTRACT

Provided is plumbing adaptor including a bore piece adapted to be inserted into a cock fitting, the bore piece including an extension movable in association with the bore piece to extend toward the inside of the cock fitting as required, a horizontal piece extending from the bore piece, and a connector adapted to be connected with a tap by extending from the horizontal piece.

### BACKGROUND OF THE INVENTION

1. Technical Field

The present invention relates to a plumbing field. In particular, the present invention relates to a tap plumbing fitting.

2. Description of the Related Art

A typical plumbing device such as a plumbing device of a shower uses two wall-fixed taps 100 and 100A as shown in FIGS. 1 and 2.

One of them controls hot water and the other controls cold water.

Those taps consist of a mechanical shaft 110 and a cock fitting 200.

The mechanical shaft 110 is mounted in the cock fitting 200 and supports a handle 120 and a valve washer 130 at the opposite end thereof.

Upon rotation of the mechanical shaft 110, a flow in the valve washer 130 is adjusted by a valve formed by a valve seat 210 in the cock fitting 200 and the valve washer 130 and leaves the cock fitting 200 through an outlet 230, thus being mixed with other tap water before being discharged through an outlet such as a shower head 300 or a tap mouth.

The cock fitting 200 is usually installed in a stone wall 400 or on the rear of the wall covered with at least ceramic tiles.

However, if a pipe inside the wall is out of order, the wall 400 has to be destroyed to replace the broken pipe with a new one.

If a user desires to change tap action to install a single lever tap consisting of a single lever for cold water and hot water for replacement of the two taps, the user cannot use the system and thus the wall has to be destroyed and the system laid under the wall has to be completely removed, after which new construction has to be performed.

### SUMMARY OF THE INVENTION

It is therefore an object of the present invention to allow cold water and hot water, which are supplied through a cold water pipe and a hot water pipe, to be supplied by a single lever instead of being supplied through a shower head by merely removing a cold water lever and a hot water lever without a plumbing system laid under a wall, and then mounting a single level when a user desires to replace the cold water lever and the hot water lever with the single lever in a state where the plumbing system for spraying a mixture of the cold water and the hot water through the shower head by means of the cold water level and the hot water level is laid under the wall, whereby a single lever tap can be installed without destroying the wall.

According to one aspect of the present invention, there is provided a plumbing adaptor including a bore piece adapted to be inserted into a cock fitting, the bore piece including an extension movable in association with the bore piece to extend toward the inside of the cock fitting as required, a horizontal piece extending from the bore piece, and a connector adapted to be connected with a tap by extending from the horizontal piece.

The extension in the bore piece is adapted to allow the bore piece to be inserted into the inner side of the cock fitting having a variable length. The extension may extend from the bore piece to contact the rear surface of the cock fitting.

The bore piece may include an inlet and the connector may include an outlet.

The outlet of the connector and the inlet of the bore piece may extend through the bore piece, the horizontal piece, and the connector such that they are in a fluid communication state.

The bore piece may include a thread on an inner side thereof, and the extension may include a thread on an outer side thereof to be movable in association with the bore piece.

The bore piece and the connector may include threads on outer sides thereof.

The horizontal piece may extend in perpendicular to an axis of the bore piece such that rotation of the adaptor changes a horizontal distance between the bore piece and the connector.

According to another aspect of the present invention, there is provided a plumbing adaptor system including a two plumbing adaptors according to any one of the previous claims, and a tap connector comprising a tap through which cold water and hot water are discharged, wherein each of the adaptors includes a bore piece adapted to be inserted into a cock fitting, the bore piece including an extension movable in association with the bore piece to extend toward the inside of the cock fitting as required, a horizontal piece extending from the bore piece, and a connector adapted to be connected with a tap by extending from the horizontal piece, and each of the adaptors is adapted to be positioned inside a cock fitting, and the tap connector is designed to connect the two adaptors to the single tap.

### BRIEF DESCRIPTION OF THE DRAWINGS

FIG. 1 is an exploded perspective view showing a conventional tap;

FIGS. 2A through 2C are a side cross-sectional view, a plan cross-sectional view, and a front view, respectively to show a structure of a conventional tap;

FIG. 3 is an exploded perspective view showing a structure of the present invention;

FIG. 4 is a cross-sectional view showing a structure of an adaptor fitting according to the present invention;

FIG. 5 is a front view showing a state where a single lever tap is installed by using an adaptor fitting according to the present invention; and

FIGS. 6A through 6C are views showing states where an adaptor fitting is coupled to a cock fitting, and a view showing an installed state to show an assembled state of an adaptor fitting according to the present invention.

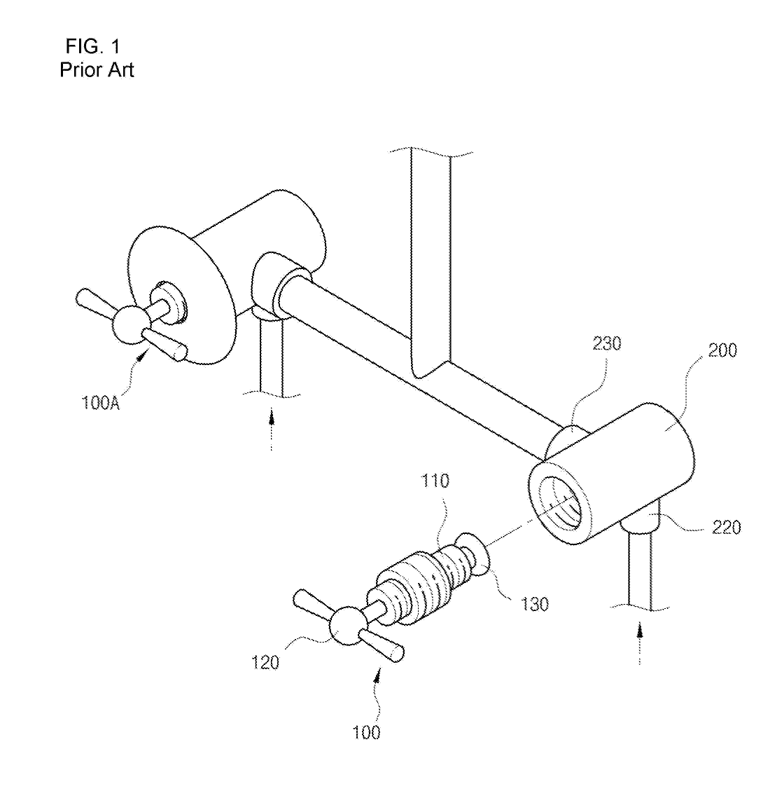

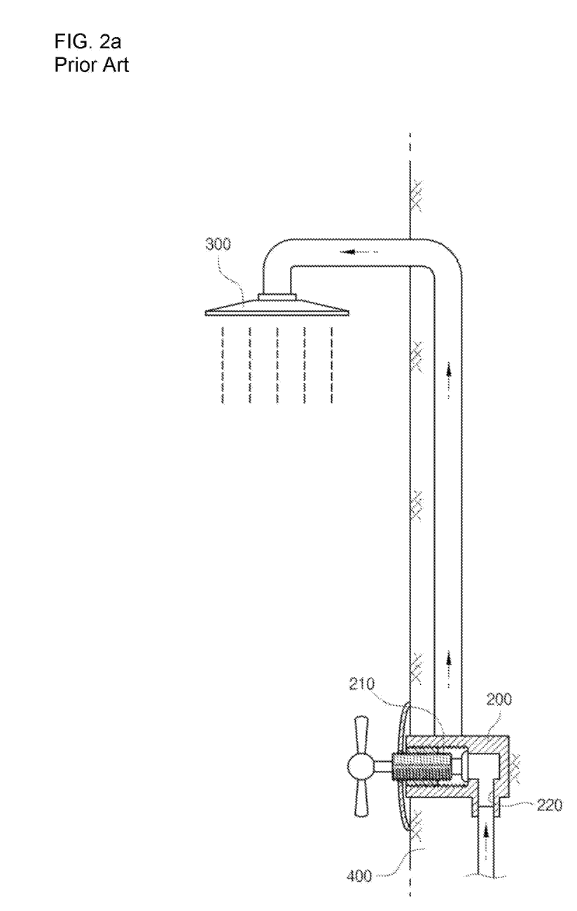

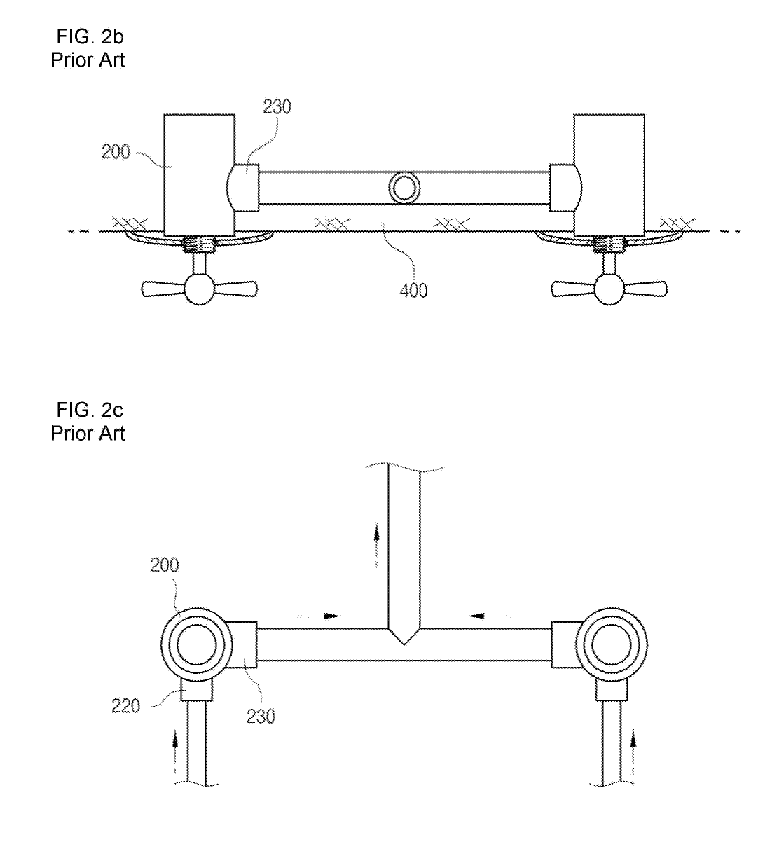

### DETAILED DESCRIPTION OF THE EMBODIMENT

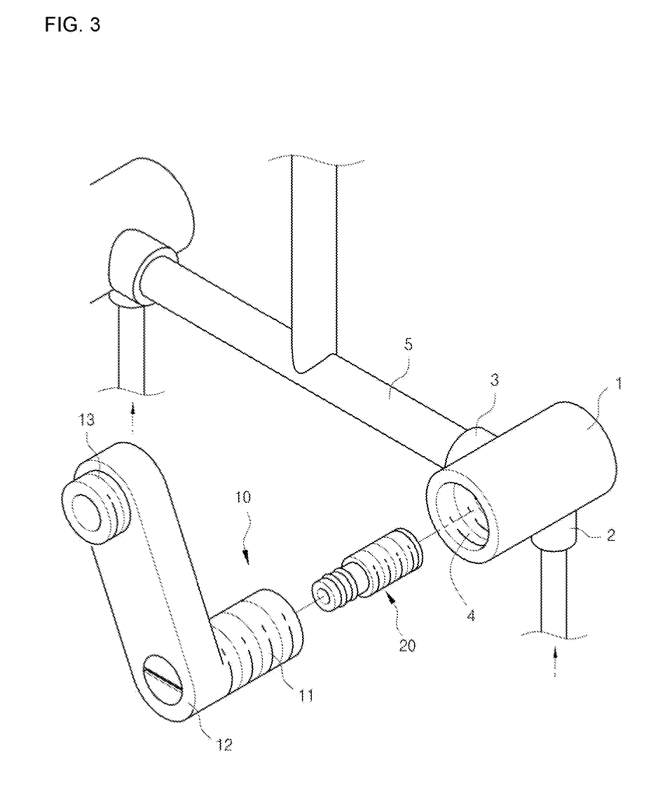

FIG. 3 is an exploded perspective view showing a structure of the present invention. A conventional plumbing device where a cock fitting 1 having an inlet 2 and an outlet 3 through which cold water and hot water are introduced is connected with a connecting pipe 5 at the outlet 3 thereof is laid under a wall.

The cock fitting 1 is exposed to the outside of the wall on a part of a front portion thereof, and has a valve seat 4 having a thread on an inner periphery thereof.

An end portion of an adaptor fitting 10 according to the present invention is connected to the valve seat 4 of the cock fitting 1 exposed to the outside of the wall, and a single lever tap 50 is connected to a front end of the adaptor fitting 10, such that a mixed water having a user desired temperature can be discharged by performing on/off operations based on up/down control of the single lever and adjusting the inflow of the cold/hot water based on left/right control of the single lever.

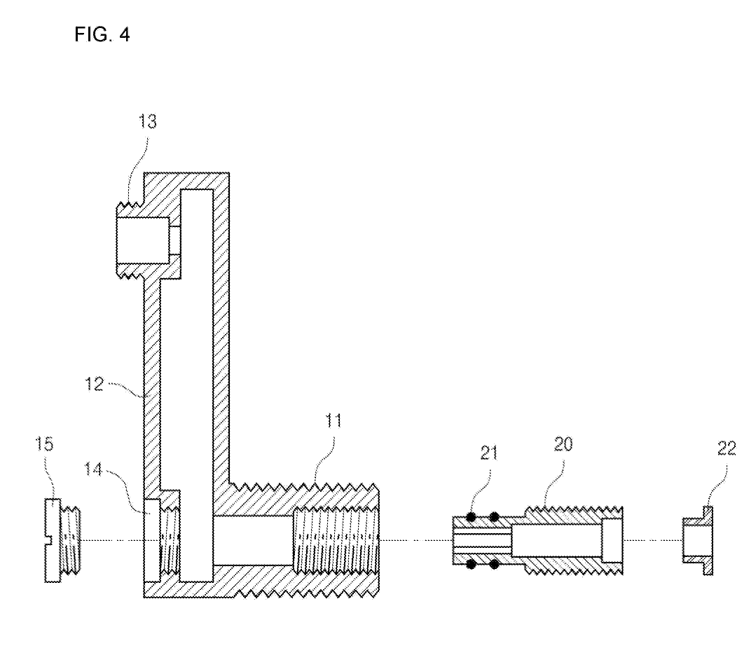

The adaptor fitting 10 according to the present invention is shown in detail in FIGS. 3 and 4.

The adaptor fitting 10 includes a bore piece 11 having a thread on an outer portion thereof, and a connector 13 connected to a horizontal piece 12.

Fluid communication is made through the adaptor fitting 10, which permits the flow of tap water through the single lever tap 50 after passing through the bore piece 11 connected with the cock fitting 1, the horizontal piece 12, and the connector 13.

The bore piece 10 includes an inner extension 20.

The internal extension 20 can move in association with the bore piece 11.

In the use situation, the bore piece 11 has a thread at an inner side thereof, and also has a thread at an outer side thereof such that the inner extension 20 can extend movably from the bore piece 11 when the bore piece 11 is coupled into the cock fitting 1. The inner extension 20 may extend such that an end side thereof contacts the valve seat 4 of the cock fitting 1.

Hence, the adaptor fitting 10 is inserted into the cock fitting 1 having various lengths without using additional connectors.

The horizontal piece 12 extends from the bore piece 11, and a horizontal distance between the bore piece 11 inserted into the cock fitting 1 and the connector 13 functioning as a connecting means including a tap can be changed by positioning.

In the use situation, conventionally used tap mechanical shafts are removed from the respective cock fittings 1 in the tap system, and the adaptor fittings 10 according to the present invention are inserted into the cock fittings 1.

Such a structure may be achieved by screw-fixing the bore piece 11 into the cock fitting 1 and then extending the inner extension 20 to a position which allows a closing washer 21 to be compressed between an end of the inner extension 20 and the valve seat 4 of the cock fitting 1.

Consequently, the compressed closing washer 21 prevents the flow of tap water to leak outside the outlet 3 of the cock fitting 1.

When the adaptor fitting 10 is inserted into the cock fitting 1, the inner extension 20 provided in the adapator fitting 10 blocks the flow of the tap water to the outlet 3 provided at an end of the cock fitting 1.

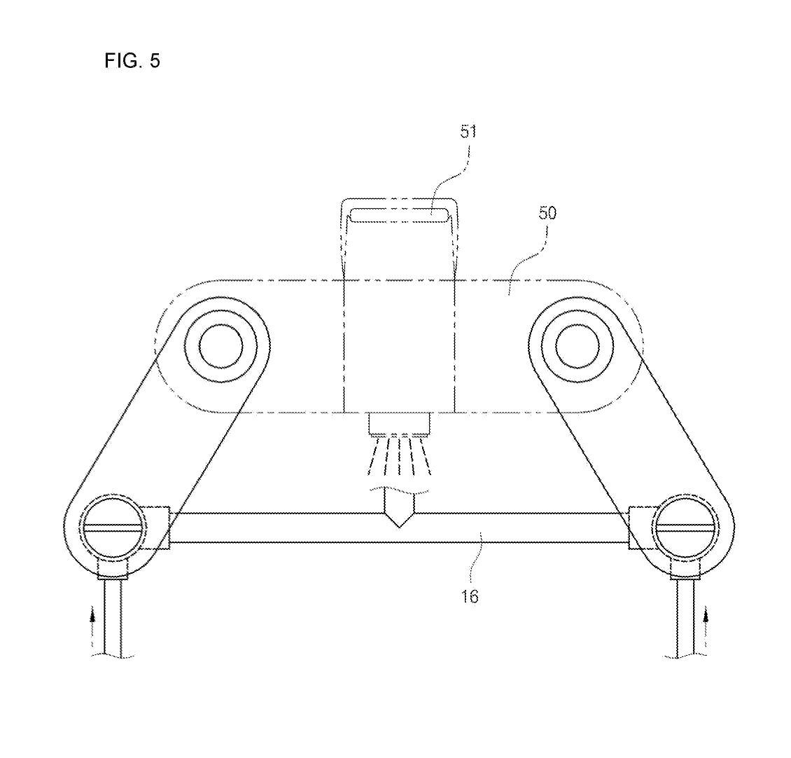

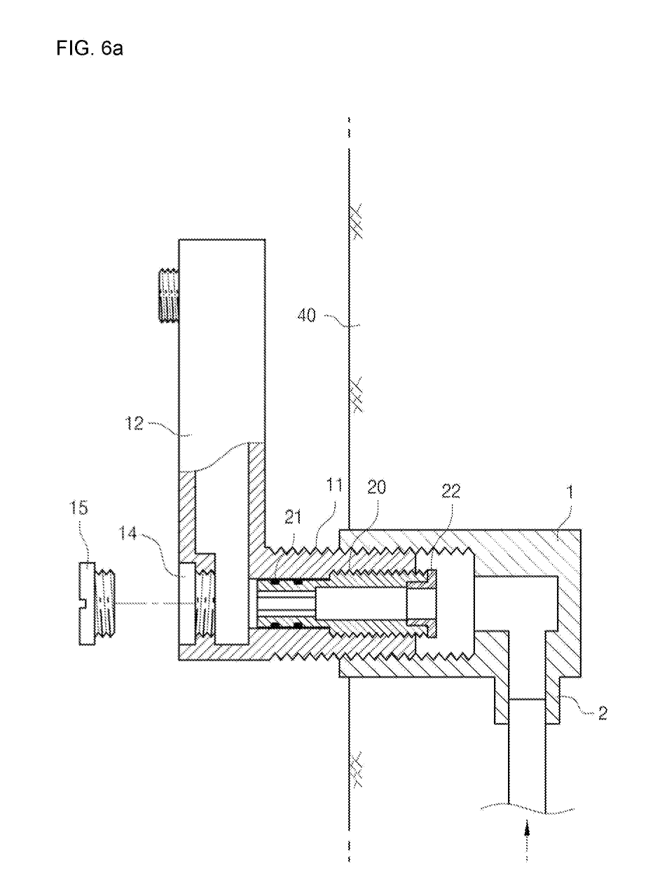

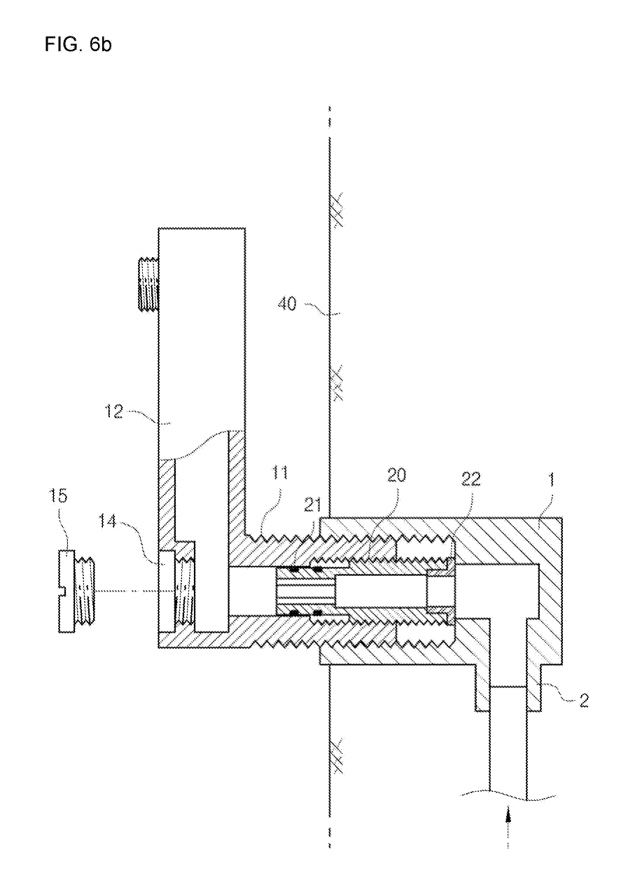

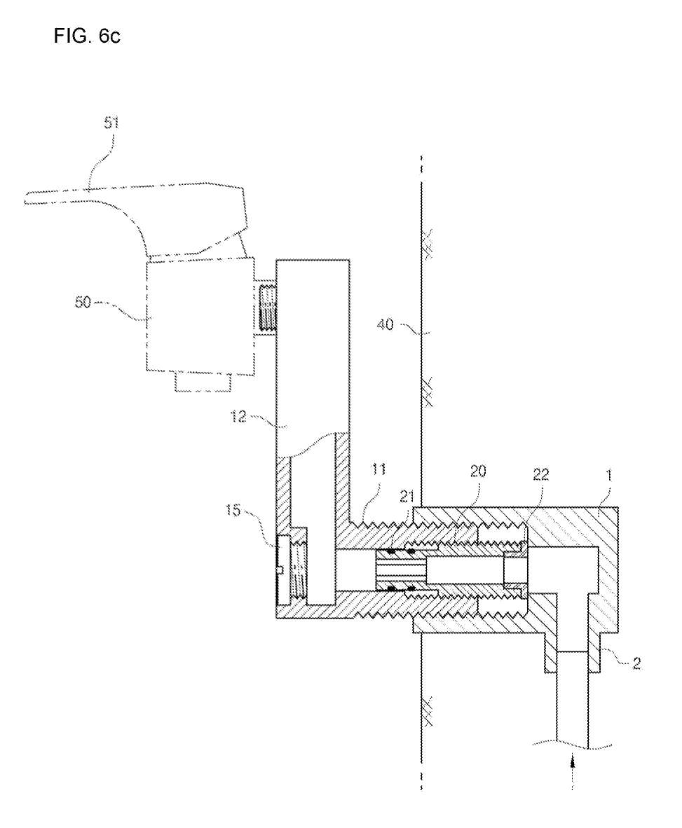

FIG. 5 is a front view showing a coupled state with the single lever tap 50 by using the adaptor fitting 10 according to the present invention, and FIGS. 6A through 6C are views showing a use state of the adaptor fitting 10 according to an embodiment of the present invention.

FIG. 6A is a view showing that the two cock fittings 1 are mounted under the stone wall 40.

A mixing horizontal pipe 16 under the wall 40 is adapted to communicate with a vertical pipe 17 so as to deliver the mixed tap water to a shower head (not shown).

However, the mechanical shafts of the taps 100 and 100A have been removed from the cock fittings 1 and the adaptor fittings 10 are connected taking the place of the removed mechanical shafts.

That is, as shown in FIG. 6A, an end of each adaptor fitting 10 is fixedly mounted into the cock fitting 1 by means of a screw and the other end, the connector 13, thereof is fixedly mounted into the tap 50 by means of a screw.

An opening/closing lever 51 of the single lever tap 50 is manipulated by a well-known method to control the amount, flow, and temperature of tap water discharged from the tap mouth.

When the adaptor fitting 10 is inserted into the cock fitting 1, a jig is inserted through an opening 14 provided on the front face of a lower side of the horizontal piece 12 to turn the inner extension 20 connected into the bore piece 11, such that a terminal of the inner extension 20 closely contacts the valve seat 4 as shown in FIG. 6B. Once the inner extension 20 closely contacts the valve seat 4, the jig, which has rotated the inner extension 20, is removed through the opening 14 and then a blocking cap 15 is engaged to the opening 14 as shown in FIG. 6C. In this way, the water introduced through the inner extension 20 can flow through the horizontal piece 12 without leaking through the opening 14, and the tap water introduced into the cock fitting 1 through the inlet 2 can be prevented from flowing to the connecting pipe 5 through the outlet 3.

At the terminal of the inner extension 20 is provided a rubber packing 22 such that the rubber packing 22 is urged to closely contact the valve seat 4 to prevent leakage of the tap water.

The tap water flows through the adaptor fitting 10 through the inner extension 20, thus being introduced to the tap 50.

It can be understood that the length of the horizontal piece 12 allows the adaptor fitting 10 to be positioned at a variable horizontal position which changes a distance between the cock fittings 1, while still maintaining connection with the tap 50 having a fixed size from which the cold water and the hot water flow.

It can also be understood that the inner extension 20 allows positioning of the adaptor fitting 10 at the cock fitting 1 regardless of the cock fitting 1.

Herein, referred prior art forms a part of common knowledge in the corresponding field in Australia or other countries.

As is apparent from the foregoing description, in the use of the plumbing system which sprays water from the cold water pipe and the hot water pipe laid under the wall, which is mixed by manipulation of the cold water control lever and the hot water control lever, through the shower head, only the cold water control lever and the hot water control lever are removed while using the plumbing system laid under the wall, such that the cold water and the hot water are not supplied to the shower head in spite of installation of the single lever tap. Therefore, it is possible to avoid the inconvenience of destroying the wall for use of the single lever tap and completely removing the plumbing system which is laid under the wall.

Unless otherwise indicated by an explicit word or a necessary implicit meaning in the appended claims and the foregoing detailed description, the word “comprising” is used with a comprehensive meaning, i.e., is used to specify existence of the foregoing features, but not to exclude existence or addition of other features in various embodiments of the present invention.

What is claimed is:

1. A plumbing adaptor comprising:
a bore piece adapted to be inserted into a cock fitting, the bore piece comprising an extension movable in association with the bore piece to extend toward the inside of the cock fitting as required;
a horizontal piece extending from the bore piece; and
a connector adapted to be connected with a tap by extending from the horizontal piece.

2. The plumbing adaptor of the claim 1, wherein the bore piece comprises an inlet and the connector comprises an outlet.

3. The plumbing adaptor of claim 1, wherein the outlet of the connector and the inlet of the bore piece extend through the bore piece, the horizontal piece, and the connector such that they are in a fluid communication state.

4. The plumbing adaptor of one of the claim 1, wherein the bore piece comprises a thread on an inner side thereof, and the extension comprises a thread on an outer side thereof to be movable in association with the bore piece.

5. The plumbing adaptor of one of the claim 1, wherein the bore piece and the connector comprise threads on outer sides thereof.

6. The plumbing adaptor of one of the claim 1, wherein the horizontal piece extends in perpendicular to an axis of the bore piece such that rotation of the adaptor changes a horizontal distance between the bore piece and the connector.

7. A plumbing adaptor system comprising:
a two plumbing adaptors according to any one of the previous claims; and
a tap connector comprising a tap through which cold water and hot water are discharged,
wherein each of the adaptors is adapted to be positioned inside a cock fitting, and the tap connector is designed to connect the two adaptors to the single tap.
